(19) United States
(12) Patent Application Publication
(10) Pub. No.: US 2012/0078704 A1
(43) Pub. Date: Mar. 29, 2012

(54) INTERNET-BASED METHODS OF OFFERING ADVERTISING

(76) Inventor: Thomas Harry Spence, III, Plymouth, MN (US)

(21) Appl. No.: 13/309,572

(22) Filed: Dec. 2, 2011

Related U.S. Application Data
(63) Continuation of application No. 12/960,502, filed on Dec. 5, 2010.
(60) Provisional application No. 61/267,034, filed on Dec. 5, 2009.

(51) Int. Cl. G06Q 30/02

(52) U.S. Cl. 705/14.36

(57) ABSTRACT

The present invention provides methods of offering advertisements on the Internet, and systems for implementing these methods. These methods offer users an accrued financial incentive to purchase products and services from advertisers. In some embodiments, a method of offering advertisements on the Internet comprises: providing one or more advertisements at an Internet site; allowing for a user to click or view the advertisements; increasing the user's account balance after an advertisement is viewed; and offering cash or a non-cash equivalent to a winning user having the highest relative value of an account balance within a selected pool of account balances. Certain embodiments of this invention relate to an Internet business known as Mascot Race.

### PRIORITY DATA

This patent application is a continuation application under 35 U.S.C. §120 of U.S. patent application Ser. No. 12/960,502, filed Dec. 5, 2010, which claims priority under 35 U.S.C. §119 from U.S. Provisional Patent Application No. 61/267,034, filed Dec. 5, 2009, the disclosures of which are each hereby incorporated by reference herein for all purposes.

### FIELD OF THE INVENTION

The present invention relates generally to the fields of e-commerce systems and advertising services provided on the Internet.

### BACKGROUND OF THE INVENTION

Advertisements have been used to promote and sell products and services through a wide variety of media including television, radio, billboards, magazines and, more recently, the Internet. In exchange for receiving free or subsidized content or programming, the viewer or user is exposed to advertisements which support the cost of producing and providing the content or programming. This method of advertising has been applied to every type of media from commercials in radio and television, to advertisement pages in newspapers and magazines, to banner ads on Internet pages.

Typically, advertisements have been passively presented through these media channels. For example, while a person is watching television, periodically one or more commercials will be displayed. Commonly, banner ads will be included on web pages, but users can very easily ignore them. Some small fraction of users may ultimately click on such banner ads, but it is not a very effective method of Internet-based advertising.

What are currently needed are methods and systems to provide financial incentives to users so that they are more likely to actively view an advertisement. Active, rather than passive, clicking or viewing of Internet ads will increase the likelihood that a user actually views the ad, which in turn increases the likelihood that the user will purchase a product or service, or otherwise react positively to a brand message. Preferably, no skill or consideration is required from users to utilize these improved methods and systems.

### SUMMARY OF THE INVENTION

In some variations, the present invention provides a method of offering advertisements on the Internet, the method comprising:
(a) providing, to a plurality of users, one or more advertisements at an Internet site;
(b) allowing for an individual user to click or view the one or more advertisements;
(c) establishing an account balance for the individual user;
(d) during or after the one or more advertisements are clicked or viewed by the individual user, increasing the account balance associated with the individual user;
(e) calculating relative values of account balances within a selected pool of account balances associated with at least a portion of the plurality of users; and
(f) offering a cash or non-cash equivalent to at least one selected user, based at least in part on the selected pool of account balances.

Preferably, each of the plurality of users is a registered user, or becomes registered prior to step (d). In some embodiments, the increasing an account balance associated with the individual user in step (c) is not performed until after the advertisements are viewed entirely. The cash or non-cash equivalent may be awarded to a winning user having the highest account balance within the selected pool of account balances.

In some embodiments, the one or more advertisements are each selected from the group consisting of banner ads, rich-media ads, interstitial ads, floating ads, wallpaper ads, pop-up ads, pop-under ads, video ads, mobile ads, superstitial ads, TV-like ads, and combinations of any of the foregoing. In certain embodiments, at least one of the advertisements is a video ad with a duration selected from about 5 seconds to about 1 minute, such as about 10 seconds to about 15 seconds.

The method, in some embodiments, includes providing at least one advertisement precursor at the Internet site, allowing for an individual user to click the advertisement precursor, and linking the advertisement precursor to an advertisement which is then displayed to the individual user.

In preferred embodiments, each of the one or more advertisements is activated only following an active step taken by a user. Optionally, the method does not include offering a passive advertisement to the user.

In some embodiments of the invention, the account balance associated with an individual user is increased in response to an active step taken by the user, resulting in the user being routed to a third-party web site.

The method may further include allowing some or all of a user's account balance to be redeemable for cash or non-cash value. Additionally, the method may further include allowing some or all of a user's account balance to be sold, traded, or bartered between or among the plurality of users.

A Monte Carlo (probabilistic) calculation step may be utilized to determine one or more winners of cash or non-cash equivalents, if desired.

Some variations of the invention provide a system for offering advertisements on the Internet, the system comprising a server computer configured to exchange data with a network, the server computer having a processor, an area of main memory for executing program code under the direction of the processor, a storage device for storing data and program code and a bus connecting the processor, main memory and the storage device; the code being stored in the storage device and executing in the main memory under the direction of the processor, to perform the steps of:
(a) providing, to a plurality of users, one or more advertisements at an Internet site;
(b) allowing for an individual user to click or view the one or more advertisements;
(c) establishing an account balance for the individual user;
(d) during or after the one or more advertisements are clicked or viewed by the individual user, increasing the account balance associated with the individual user;
(e) calculating relative values of account balances within a selected pool of account balances associated with at least a portion of the plurality of users; and
(f) offering a cash or non-cash equivalent to at least one selected user, based at least in part on the selected pool of account balances.

Certain variations of the invention provide a method of offering a free online forum for a plurality of registered users to compete against each other for cash or non-cash equivalents, the method comprising:
(a) providing to an individual user, on an Internet site, one or more mascot races each comprising graphic and/or text indicators of two teams involved in a sporting event;
(b) allowing the individual user to actively vote for one of the two teams involved in a selected mascot race;
(c) establishing an account balance for the individual user;
(d) in response to the vote in step (b), displaying an Internet advertisement for viewing by the individual user;
(e) after the advertisement is displayed for the individual user, increasing the account balance associated with the individual user;
(f) if the individual user votes for a winning team of the selected mascot race, increasing the account balance associated with the individual user;
(g) calculating relative values of account balances within a selected pool of account balances associated with at least a portion of the plurality of registered users; and
(h) offering a cash or non-cash equivalent to at least one selected user, based at least in part on the selected pool of account balances.

In some embodiments of this free online forum, the Internet advertisement is a video ad with a duration selected from about 5 seconds to about 1 minute, such as about 10 seconds to about 15 seconds.

The account balance associated with an individual user may be increased in response to at least one referral of a new user to the online forum. The number or values of awards may depend on the aggregate totals of votes submitted in the mascot races by registered users, the aggregate totals of winning mascot race votes, the aggregate number of new users referred by registered users, or a combination of these factors.

The graphic and/or text indicators, in some embodiments, include official or unofficial team mascots. In certain embodiments, at least some of the team mascots (or other graphic and/or text indicators) are linked to third-party web sites.

### BRIEF DESCRIPTION OF THE FIGURES

FIG. 1 depicts an exemplary method and system for offering Internet advertisements, in some embodiments of the invention.

FIG. 2 shows a sketch of a web page relating to the Example herein, according to some embodiments of the invention.

### DETAILED DESCRIPTION OF EMBODIMENTS OF THE INVENTION

Certain embodiments of the present invention will now be further described in more detail, in a manner that enables the claimed invention so that a person of ordinary skill in this art can make and use the present invention.

Unless otherwise indicated, all numbers expressing values, parameters, odds, and so forth used in the specification and claims are to be understood as being modified in all instances by the term “about.” Accordingly, unless indicated to the contrary, the numerical parameters set forth in the following specification and attached claims are approximations.

As used in this specification and the appended claims, the singular forms “a,” “an,” and “the” include plural referents unless the context clearly indicates otherwise. Additionally, all references to a “point” or “points” should be construed to include numbers or fractions of numbers, including less than 1.

Unless defined otherwise, all terms used herein have the same meaning as is commonly understood by one of ordinary skill in the art to which this invention belongs. If a definition set forth in this section is contrary to or otherwise inconsistent with a definition set forth in patents, published patent applications, and other publications that are herein incorporated by reference, the definition set forth in this specification prevails over the definition that is incorporated by reference.

Some variations of the present invention provide an advertiser-subsidized business model which allows users, free of charge, the chance to win cash or non-cash equivalents. Certain variations can be described according to a computer-implemented and/or server-implemented method and system as follows.

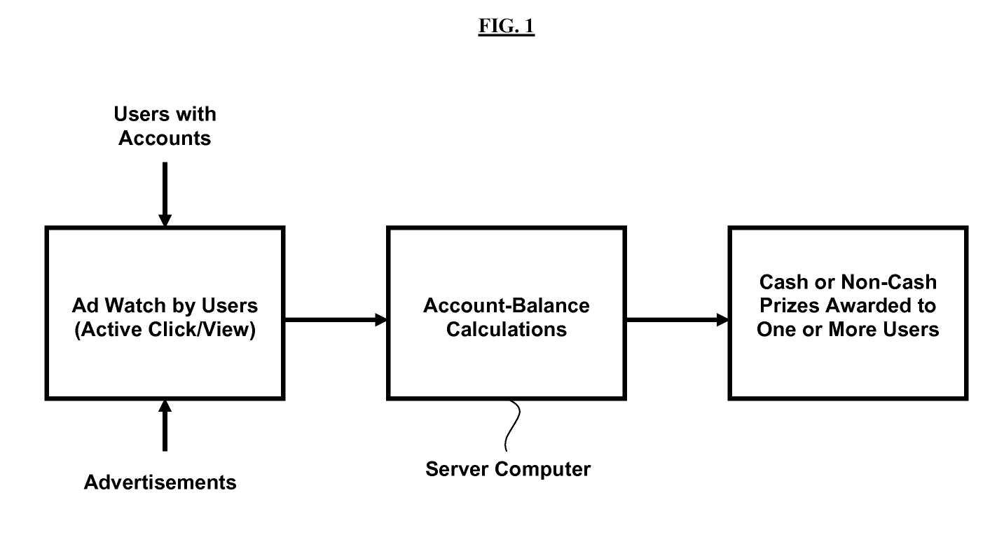

FIG. 1 depicts an exemplary method and system in variations of the invention. Non-limiting features and aspects of the present invention can be explained in the following description taken in connection with FIG. 1.

In some variations, the present invention provides a method of offering advertisements on the Internet, the method comprising:
(a) providing, to a plurality of users, one or more advertisements at an Internet site;
(b) allowing for an individual user to click or view the one or more advertisements;
(c) establishing an account balance for the individual user;
(d) during or after the one or more advertisements are clicked or viewed by the individual user, increasing the account balance associated with the individual user;
(e) calculating relative values of account balances within a selected pool of account balances associated with at least a portion of the plurality of users; and
(f) offering a cash or non-cash equivalent to at least one selected user, based at least in part on the selected pool of account balances.

The term “Internet” as used herein is intended to embrace generically all types of public and/or private communication networks using wireless and/or wired transmission media, and combinations of the above. Networks suitable for this invention include local-area networks, wide-area networks, intranets, and next-generation networks to access the World Wide Web and any of its improvements.

A “plurality of users” may be any number more than one. As will be appreciated, the number of Internet users globally is very large and any Internet user is a potential user in the context of this invention. Thus, the number of users that may be provided advertisements is not bounded. There may be any number of users simultaneously viewing various ads and accruing points.

Users may become registered at various points within these methods. For example, users may pre-register before viewing any advertisements, or users may register during or after step (a), during or after step (b), or during step (c). Preferably, users are registered prior to step (c).

An “advertiser” means a person, company, firm, agent, or other entity that can provide, or cause to be provided, one or more advertisements. “Advertisement,” “advertising,” “ads,” and similar terms used herein should be construed broadly to mean any form of online promotion that utilizes the Internet (or another large-scale network) for the purpose of delivering marketing messages to attract customers. Examples of online advertising include banner ads, rich-media ads, interstitial ads, floating ads, wallpaper ads, pop-up ads, pop-under ads, video ads, mobile ads, superstitial ads, and TV-like ads.

Some embodiments of the invention employ banner ads. Banner ads may be provided by embedding an advertisement into a web page. Banner ads may be delivered by a remote ad server via the Internet. When a user clicks on the banner ad, the user is directed to an advertiser-specified web site. This event is known as a “click through.” The advertisement may be constructed from an image (e.g., in GIF, JPEG, or PNG format), a JavaScript program, or a multimedia object employing known technologies such as Java, Shockwave, or Flash. Banner ads may employ static text and images, animation, sound, or video to maximize presence. Images are typically, although not necessarily, in a high aspect ratio (i.e. either wide and short, or tall and narrow).

Some embodiments employ interstitial ads. As intended herein, an interstitial ad is a web-page advertisement that is displayed before a user can reach additional content on a web site. An interstitial ad may include words, images, animation, video, audio, and combinations thereof. Streaming audio and/or streaming video may be employed in interstitial ads, if desired. The interstitial ad may be a full-page ad, a partial-page ad, or a pop-up ad in a separate window, for example. When a pop-up ad is employed, it may be preferred to force it (via appropriate executable code) to come to the front of the user's screen to ensure the highest likelihood that the ad is actually viewed.

Some embodiments of the invention utilize advertisement precursors, such as links that direct a user to a video or pop-up window. An “ad precursor” is a portion or region of a web page that is interactive and can respond to the action of a user by then presenting advertising content (including, for example, text, graphics, animation, video, or audio).

Thus, in some embodiments, the invention provides a method of offering advertisements on the Internet, the method comprising: providing an advertisement precursor at an Internet site; allowing for an individual user to click the advertisement precursor; and linking the advertisement precursor to an advertisement which is then displayed to the user. After the advertisement is displayed by an individual user, an account balance associated with the user may be increased. Cash or non-cash equivalents may be offered to selected user(s) based on values of account balances.

When advertisements are video ads, the window size, resolution, color levels, and video duration may vary. In some embodiments, the video ad is shown in a relatively small window embedded on a web site. In some embodiments, the video ad is shown in a pop-up window of various sizes. The resolution and colors of the video are not particularly limited but these parameters will generally influence the data requirements for loading video ads onto the user's computer or mobile device. The video duration may vary, such as from about 5 seconds to about 1 minute or more. Some embodiments employ video durations of about 10, 15, 20, 25, or 30 seconds, for example.

The number of advertisements that may be provided on a given web page may be one or a plurality of ads, such as two, three, four, five, or more. The number of advertisement precursors that may be provided on a given web page may be one or a plurality of ad precursors, such as two, three, four, five, 10, 15, 20, 25, or more.

“Click” or “view” in the present description both refer to actions that are generated by a user. A “click” refers to an active, intentional selection of a link, image, word, phrase, or other part of a web page. While “click” certainly includes a traditional mouse or touchpad click that directs a cursor to activate a link on a computer screen, there are a variety of other ways that users may actively make selections. Examples include keyboards, hot keys, touchscreens, voice commands, and so on.

A “view” refers to a display of an advertisement that results from interaction by a user, such as an interaction with an ad precursor or any other user-generated step. It is of course possible for a user to not explicitly look at the screen while an ad is being displayed. In preferred embodiments, however, the present invention maximizes value to advertisers by displaying ads following active steps taken by a user, rather than being passively or arbitrarily displayed.

The present invention contemplates that user account balances may be increased as a result of any user-directed mechanism that results in the user being routed to a third-party site. For example, at the end of a video feed a corporate partner may offer an incentive to the user to click on or view some kind of promotional offering. If the user does so, the user will receive some amount of point(s) in the user's account, whether or not anything is purchased.

During step (c), “increasing an account balance” of a user means carrying out mathematical calculations on a computer to add points, or some other form of quantitative value, to the balance associated with the user. The computer for calculating account balances may be a remote server computer connected to the user computer via the Internet. The number of points added may be an integer, such as 1, 2, or 5 points, for example. Account balances may also be increased by fractions of point, including any number of decimals (e.g., 0.1, 0.667, 1.5, etc.).

Various point values may be added to accounts and such selection may depend on many factors, such as type of ad, length of ad, time of day the ad is viewed, and so on. Point values added may, in some embodiments, depend on the profile of the user. For example, users who have referred many other users may be able to accumulate points faster by collecting bonus points, or by receiving higher multiples of points. Also, in some embodiments, point values added may depend on the nature of the specific advertiser.

Account balances may be increased during the viewing of an ad, or more preferably, after the viewing of an entire ad. The calculations, including the sending and receiving of remote data over the Internet, may begin while the ad is being viewed and then be finalized or confirmed once the ad is viewed entirely. Alternatively, an account value may be increased immediately upon a user action (such as a click of an ad or ad precursor), or after a click but prior to the conclusion of the ad view. If account value is added before an entire ad is viewed, and the user subsequently acts to actively stop the ad, such as by closing a browser, the account value that was just previously added may be removed. In some embodiments, a prorated fraction of the allocated point total for a given ad view may be deposited if a user actively stops an ad. For example, a user stopping a 15-second ad after 5 seconds may receive one-third of the allocated point total for that ad. In preferred embodiments, no points are received by a user unless an ad is viewed in its entirety.

In step (d), a relative value of a user's account balance refers to the account balance for that user relative to the account balances of other users, or relative to a certain sum of account balances. In some embodiments, account balances are ranked from highest to lowest, within a certain pool of users (i.e., selected pool of account balances). In certain embodiments, relative values may be calculated as relative fractional values by dividing an account balance of a user by the sum of account balances of a certain pool of users. Each user may thus be ascribed a relative fractional value from 0 to 1. Within a given pool, the sum of all relative fractional values will be unity, when fractional values are used.

The selected pool of account balances may be any fraction of the account balances, and can be classified for a variety of reasons, such as according to user profiles, by geography, or even randomly. In some embodiments, the selected pool includes all registered-user accounts. Pools may be static or dynamic, i.e. the pools may vary over time or as a function of any parameters associated with the system.

Users are classified, in certain embodiments, in the order they register with the system. For example, all initially registered users may be placed in a first tier, while users registering after a certain date are placed in a second tier, and so on. The pools for calculating relative account balances may follow from the tiers.

In some embodiments, a first pool of account balances consists of primary users, a second pool of account balances consists of users referred from primary users, and additional pools of account balances may be created to include multiple levels of referrals. As will be recognized, there are many ways to utilize the principles of networking, including social networking, to define multiple pools for calculating relative account balances.

There are several possibilities for the accumulation of points, in various embodiments. In some embodiments of the invention, points are accumulated within a given month (such as a calendar month or other similar period of time) but then are entirely cancelled after that month. That is, after each month, account balances are reset. Other periods of time may be employed, such as one week, two weeks, two months, three months, and so forth. Optionally, some portion of a user's account balance may remain credited upon each time transition.

In step (e), “cash” refers to money, such as in U.S. currency, which may be awarded to a user. The mechanism of cash transfer may be selected from any known currency exchange, such as hard cash, cashier's check, wire transfer to a bank account, or direct deposit to a bank account, for example.

A “non-cash equivalent” refers to anything other than money. The possibilities for non-cash equivalents are virtually unlimited, but a non-cash equivalent should have an associated monetary or economic value. Example categories of non-cash equivalents include goods, services, discounts on goods or services, and rebates for goods or services. Specific examples, for illustration purposes only, include computers and other electronic hardware, software, TVs, sporting equipment, tickets to sporting events, gift certificates, gift cards, prepaid debit cards, and so on.

The cash value of a cash or non-cash equivalent may vary widely. Exemplary cash values include (in U.S. dollars) $100, $500, $1,000, $5,000, $10,000, or $25,000. Selection of cash values will typically be dictated by economic factors depending at least to some extent on advertising revenues. Specific selection, however, is not particularly limited to any formula, and a degree of chance may be involved in some embodiments.

A winning user will typically be the user with the highest relative value within the selected pool of account balances, and at a given time (such as after each month). It is possible, however, for such a user to be disqualified from being selected for a cash or non-cash equivalent, for good reason. For example, users may be disqualified for cheating or other improper conduct.

Cash or non-cash equivalents may be awarded to more than one user within a selected pool. For example, cash or non-cash equivalents may be awarded to 1, 2, 3, 4, 5, 6, 7, 8, 9, 10 or more users within a selected pool at a selected point in time. Also, various combinations of cash and non-cash equivalents may be awarded. As an example, a top user (highest account balance) may receive cash while a second user (second-highest account balance) may receive a non-cash equivalent.

While awards may be based entirely on the selected pool of account balances, other factors may be considered. In some embodiments, cash or non-cash equivalents are awarded based in part on the relative account balance of the user compared to the selected pool of account balances, and in part on some other factor that is independent of account balances within the selected pool. The other factor may be a discretionary factor invoked by the operator of the method and system of the invention.

In certain embodiments, the other factor relates not to the selected pool (which contains the user), but rather to a second pool of users. The second pool may or may not contain the user. The second pool may be the entirety of user accounts, for example. When multiple factors are considered in determining awards, various weightings may be placed on the different factors. The fractional weighting for the user's account balance relative to the selected pool of account balances should be higher than 0, up to and inclusive of 1.

Certain embodiments of the invention may employ a Monte Carlo calculation step to determine one or more winners of cash or non-cash equivalents. Monte Carlo methods and algorithms are well-known in statistics and utilize non-deterministic algorithms to compute an output from various inputs. In the context of the present invention, a Monte Carlo calculation step makes it possible (but unlikely) for a user without the highest account balance within a selected pool, to win the top award. As a simple example, consider that user A has 10 points, user B has 5 points, and user C has 2 points. Using the Monte Carlo alternative, a probabilistic calculation can be made with the chances attributed to each user following from their relative point totals in a selected probability distribution. In one embodiment, users A, B, and C have (10/17)⁴, (5/17)⁴, and (2/17)⁴ relative chances, respectively, of winning (Note that the exponents may vary to adjust the probability distribution.) In this scenario, there would be a 94% chance of user A winning This approach makes it very likely that A will still win but gives users who know they have low account balances to do everything they can do increase their balances (that is, click or view more ads). All users have a greater than zero chance of winning, even if the chance is low or very low. Optionally, a top user may automatically be given a top award of cash or a non-cash equivalent, while other winners are determined probabilistically.

Other embodiments introduce additional incentives for users to increase their account balances even if they have low chances of winning the cash or non-cash award. In some of these embodiments, points that are generated and accumulated are redeemable for either cash or non-cash value directly or indirectly from third parties, such as third-party sponsors, for items such as goods, services, rebates, discounts on goods or services, and so on. In this fashion, a user does not need to be a winning user to be capable of monetizing his or her account points.

Certain embodiments provide additional possibilities for users to utilize points. Optionally, the methods and systems of the invention may allow for points to be sold, traded, or bartered between or among registered users. Users may wish to buy, sell, or trade points for a variety of reasons. In these embodiments, a web page within a web site, or a different web site, may be utilized as a trade exchange for user points. In other words, a trading and bartering platform and bookkeeping system may be provided for registered users.

System variations of the invention will now be further described. In some variations, the present invention provides a system for offering advertisements on the Internet, the system comprising a server computer configured to exchange data with a network, the server computer having a processor, an area of main memory for executing program code under the direction of the processor, a storage device for storing data and program code and a bus connecting the processor, main memory and the storage device; the code being stored in the storage device and executing in the main memory under the direction of the processor, to perform the steps of:
(a) providing, to a plurality of users, one or more advertisements at an Internet site;
(b) allowing for an individual user to click or view the one or more advertisements;
(c) establishing an account balance for the individual user;
(d) during or after the one or more advertisements are clicked or viewed by the individual user, increasing the account balance associated with the individual user;
(e) calculating relative values of account balances within a selected pool of account balances associated with at least a portion of the plurality of users; and
(f) offering a cash or non-cash equivalent to at least one selected user, based at least in part on the selected pool of account balances.

Users may access the system of the invention using any current or future means for accessing the Internet, including but not limited to a desktop or laptop computer, a mobile computer, a cell phone with Internet connectivity, a handheld device, a tablet computer, an Internet-connected TV, an Internet-connected multimedia device, and any other means for Internet access.

A “computer server” (or “server computer,” or “server”) for the purposes of the present invention includes a processor and memory. In accordance with the present invention, a server is capable of communicating on a computer network, such as the Internet. The server includes a suitable link to the network, which is linked to a plurality of user computers or other network devices.

The server can actually be a network of individual computers or processing units, as is known in the art. For example, servers may be distributed across large geographies (including within and/or outside the United States), and may utilize cloud computing. Cloud computing is Internet-based computing, whereby shared resources, software, and information are provided to computers and other devices on demand, as with the electricity grid.

The server computer for calculating account balances may be a remote server computer connected to user computers via the Internet. Technically speaking, the calculations (or a portion thereof) may be performed on a user computer, such as in the user computer's RAM or flash drive, or some other rewritable section of secure memory. The output of these calculations may then be transmitted to the remote server computer for updating account balances, comparing relative account balances, and other necessary calculations.

The server computer also stores data associated with users and advertisers. In some embodiments, the server computer also stores advertisements themselves. In these or other embodiments, advertisements are not stored on the server but rather stored somewhere else, such as memory storage owned or controlled by the advertiser. Ad content may include any known formats, such as (but not limited to) HTML, Java, Shockwave, or Flash.

### EXAMPLE

This example of the invention relates to a system and method called Mascot Race™. Mascot Race is a trademark owned by the present Applicant. The web site www.mascotrace.com is a registered Internet domain name owned by the present Applicant. The name “Mascot Race” and the associated domain name should not be construed to limit the invention in any way. Also, the invention is by no means limited to the scope of this particular example.

Mascot Race is an Internet business which provides users (such as sports enthusiasts) a free online forum to compete against one another based on selected monthly sporting events. Users sign up and vote for teams they want to win, or teams they predict will win, a sporting event. Signing up and voting is free of charge to users. Each vote cast must be preceded by the user being exposed to a brief (about 10-15 seconds) video advertisement. Users have the opportunity to be awarded cash or non-cash equivalents based on the number of points, called “MR Points” in this example, that have been deposited into their accounts.

The sports may include, for example, baseball, basketball, football, and hockey, each at the professional (e.g., MLB, NBA, NFL, or NHL) or college (e.g., NCAA) levels. The sports subject to mascot races may further include racing leagues, such as National Association for Stock Car Auto Racing (NASCAR) or the Indy Racing League (IRL). Other sports, including leagues within the United States and leagues worldwide (e.g., soccer or tennis), may be included in variations of this example.

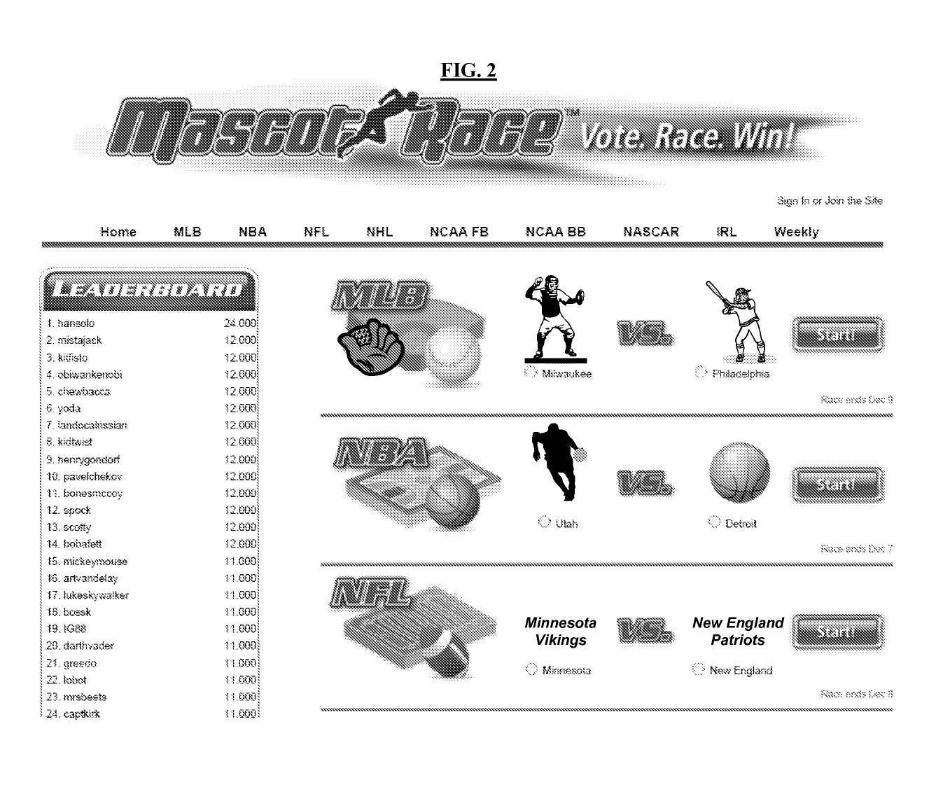

As depicted in FIG. 2, a web site is provided which contains two columns of selected sports teams with their graphical mascots lined up against each other in what are referred to in this example as “mascot races.” The mascot races are shown in individual rows. It is preferred, although not necessary, that the mascots are the official mascots of the respective sports teams. For the purposes of describing the present invention, a “mascot” may refer to any unique indicator of a team, whether in graphical or text form, or a combination thereof.

As a variation within this example, each row may include some other graphical or non-graphical indictor of a sports team, such as a logo, a picture, a sketch or drawing, or text. In the case of a text-based indicator of a team, the text may include, but is not limited to, the name and/or the nickname of a team. Various combinations are possible. For instance, a given team may be shown with both a mascot and a line of text near the mascot, which may be desirable in cases where the mascot is not well-known to persons unfamiliar with a team. Or, a given team may be depicted with a mascot and a line of text, in alternating fashion. Some mascot races may include graphical mascots or logos while other mascot races may include text, and so forth.

Mascot races may be shown on a single web page or on multiple web pages. Preferably, the mascot races are grouped by sport in separate web pages located within the web site. Optionally, a certain web page shows selected events, across multiple sports, for a given period of time (such as weekly). Each mascot race represents sports teams that are actually scheduled to play each other in a real sporting event within a given month.

In this example, as indicated in FIG. 2, a logo associated with the appropriate sporting league appears on each line for a mascot race. Such a sport-specific logo may be the official logo or some other graphical depiction, such as a field-goal post for football, a basketball hoop for basketball, etc. Additionally, one or more brand logos associated with Mascot Race may be included at the web site.

A user may select a team involved in a certain mascot race and choose the start button to cast a vote. The user will be required to log into the site and register if the user has not previously registered. The registration information may be used by a user to return and vote on mascot races. For a given mascot race, a user may only vote once per day. The user name may be seen by other users at the web site.

Each row indicates when the respective mascot race ends, so that users are provided date (and possibly time) deadlines to vote for a given race. Optionally, the web site may graphically depict, and/or include text indicating, which of the teams has a greater number of votes cast than for the other team, for a given mascot race. In this example, the indication of which team has more votes cast is not provided until after the user casts a vote.

There are various ways in which users may earn points or fractions thereof. In the context of the present example, earned points or fractions of points are referred to as “MR Points.” Users may earn MR Points by casting votes on mascot races. Users who vote for the sports teams which actually win the applicable sporting event, will earn MR Points. Additionally, users may also earn MR Points by referring new users to the web site. These referral-based MR Points may be generated upon each individual referral, or may be generated after each month or another prescribed period of time, such as weekly, quarterly, etc.

After clicking the vote button for one of two mascots, a brief advertisement will be displayed on the user's computer or mobile device. Upon completion of the ad, the user will receive 1 point in his/her MR Point account balance, in this example. To receive an MR Point, the user must allow the ad to run to completion. With each vote cast, for each mascot race, a user is required to have an advertisement displayed in its entirety.

In this example, a winning mascot of its mascot race nets the user an additional 0.364 MR Points per each vote cast for the winning mascot. A user that refers a new registered user will receive 0.711 MR Points per new user. A monthly leaderboard (shown in FIG. 2) summarizes the current MR Point leaders.

At the end of each month, a certain number of users (such as one, two, five, or ten) with the highest MR Point totals will receive cash payouts. Point balances are reset for all users for the next month. In this particular example, the top ten MR Point earners per month will receive cash awards. Exemplary cash awards are $1,000, $5,000, $10,000, or more.

The number of awards and/or the values of awards may depend on the number of advertising displays in a given month. That is, cash or non-cash equivalents may be funded in part or entirely from advertising revenue, i.e. revenue received from one or more sponsoring companies wishing to advertise at the Mascot Race web site. Optionally, the number and/or values of cash or non-cash equivalents awarded may depend on the aggregate totals of votes submitted on individual mascot races by registered users. Alternatively, or additionally, the number and/or values of cash or non-cash equivalents awarded may depend on the aggregate number of new users referred by registered users on a monthly basis.

Advertisements are supplied from corporate sponsors, by direct Internet feeds, by data stored within a server computer associated with Mascot Race, or by some other means. As an online advertising platform, Mascot Race may offer the following to its corporate ad sponsors in various embodiments relating to this example:

(a) Customizable layouts enable corporate partners to tailor new marketing campaigns, introduce new product launches, or quickly disseminate discounted pricing initiatives.
(b) Exclusivity on a per-sport (or other category) basis may be provided. Ads within a sport will not run against the ads of any other company.
(c) Efficient pricing is offered, where sponsors only pay for the ads that are viewed.
(d) Data reporting provides detailed user demographic information. Sponsors can target the people that are most likely to buy the products of services of the sponsor.
(e) Supplemental brand advertising is included. Even when the sport that is sponsored is out of season, a company will still be allowed to display its logo on the Mascot Race web site. This logo will be seen by users who log in or check the current race results on the monthly leaderboard.

In certain variations of this example, the graphic and/or text for each team mascot may be linked to a third-party web site. The third-party web site may be an official team web site, a ticket-sales site, an apparel web site, a web site of a corporate sponsor of a team, and so on. A user who clicks a mascot itself is brought to the third-party web site, preferably in a new browser window. In these variations, the mascots provide a form of advertising for sporting teams.

Variations of this invention have utility in commerce to provide improved methods and systems of advertising, and to promote trade and economic growth, for example.

Although illustrative embodiments and examples, and various modifications thereof, have been described in detail herein, one skilled in the art will appreciate that the present application need not be limited to these precise embodiments and the described modifications, and that various changes and further modifications may be practiced without departing from the scope or spirit of the invention. Other embodiments will be apparent to those of ordinary skill in the art, including embodiments that do not provide all of the features and advantages set forth herein. These other embodiments are also within the scope of this invention.

Where methods and steps described above indicate certain events occurring in certain order, those of ordinary skill in the art will recognize that the ordering of certain steps may be modified and that such modifications are in accordance with the variations of the invention. Additionally, certain of the steps may be omitted or performed concurrently in a parallel process when possible, as well as performed sequentially.

Therefore, to the extent that there are variations of the invention, which are within the spirit of the disclosure or equivalent to the inventions found in the appended claims, it is the intent that this patent will cover those variations as well. The present invention shall only be limited by what is claimed.

What is claimed is:

1. A method of offering advertisements on the Internet, said method comprising:
(a) providing, to a plurality of users, one or more advertisements at an Internet site;
(b) allowing for an individual user to click or view said one or more advertisements;
(c) establishing an account balance for said individual user;
(d) during or after said one or more advertisements are clicked or viewed by said individual user, increasing said account balance associated with said individual user;
(e) calculating relative values of account balances within a selected pool of account balances associated with at least a portion of said plurality of users; and
(f) offering cash or a non-cash equivalent to at least one selected user, based at least in part on said selected pool of account balances.

2. The method of claim 1, wherein said increasing an account balance associated with said individual user in step (c) is not performed until after said one or more advertisements are viewed.

3. The method of claim 1, wherein each of said plurality of users is a registered user.

4. The method of claim 1, wherein said cash or a non-cash equivalent is awarded to a winning user having the highest account balance within said selected pool of account balances.

5. The method of claim 1, wherein said one or more advertisements are each selected from the group consisting of banner ads, rich-media ads, interstitial ads, floating ads, wallpaper ads, pop-up ads, pop-under ads, video ads, mobile ads, superstitial ads, TV-like ads, and combinations of any of the foregoing.

6. The method of claim 5, wherein at least one of said one or more advertisements is a video ad with a duration selected from about 5 seconds to about 1 minute.

7. The method of claim 1, said method comprising providing at least one advertisement precursor at said Internet site, allowing for said individual user to click said advertisement precursor, and linking said advertisement precursor to said advertisement which is then displayed to said individual user.

8. The method of claim 1, wherein each of said one or more advertisements is activated following an active step taken by a user.

9. The method of claim 8, wherein said method does not include offering a passive advertisement to said user.

10. The method of claim 1, wherein said account balance associated with said individual user is increased in response to an active step taken by said user resulting in said user being routed to a third-party site.

11. The method of claim 1, said method further comprising a Monte Carlo calculation step to determine one or more winners of cash or a non-cash equivalent.

12. The method of claim 1, said method further comprising allowing some or all of a user's account balance to be redeemable for cash or non-cash value.

13. The method of claim 1, said method further comprising allowing some or all of a user's account balance to be sold, traded, or bartered between or among said plurality of users.

14. A system for offering advertisements on the Internet, said system comprising a server computer configured to exchange data with a network, said server computer having a processor, an area of main memory for executing program code under the direction of said processor, a storage device for storing data and program code and a bus connecting said processor, main memory and said storage device; said code being stored in said storage device and executing in said main memory under the direction of said processor, to perform the steps of:
(a) providing, to a plurality of users, one or more advertisements at an Internet site;
(b) allowing for an individual user to click or view said one or more advertisements;
(c) establishing an account balance for said individual user;
(d) during or after said one or more advertisements are clicked or viewed by said individual user, increasing said account balance associated with said individual user;
(e) calculating relative values of account balances within a selected pool of account balances associated with at least a portion of said plurality of users; and
(f) offering cash or a non-cash equivalent to at least one selected user, based at least in part on said selected pool of account balances.

15. A method of offering a free online forum for a plurality of registered users to compete against each other for cash or a non-cash equivalent, said method comprising:
(a) providing to an individual user, on an Internet site, one or more mascot races each comprising graphic and/or text indicators of two teams involved in a sporting event;
(b) allowing said individual user to actively vote for one of said two teams involved in a selected mascot race;
(c) establishing an account balance for said individual user;
(d) in response to said vote in step (b), displaying an Internet advertisement for viewing by said individual user;
(e) after said advertisement is displayed for said individual user, increasing said account balance associated with said individual user;
(f) if said individual user votes for a winning team of said selected mascot race, increasing said account balance associated with said individual user;
(g) calculating relative values of account balances within a selected pool of account balances associated with at least a portion of said plurality of registered users; and
(h) offering cash or a non-cash equivalent to at least one selected user, based at least in part on said selected pool of account balances.

16. The method of claim 15, wherein said Internet advertisement is a video ad with a duration selected from about 5 seconds to about 1 minute.

17. The method of claim 15, wherein said account balance associated with said individual user is increased in response to at least one referral of a new user to said online forum.

18. The method of claim 15, wherein the number or values of said cash or non-cash equivalent awarded depends on the aggregate totals of votes submitted in said mascot races by registered users, the aggregate totals of winning mascot race votes, the aggregate number of new users referred by registered users, or a combination of these.

19. The method of claim 15, wherein said graphic and/or text indicators include official or unofficial team mascots.

20. The method of claim 19, wherein at least some of said team mascots are linked to third-party web sites.
